(19) United States
(12) Patent Application Publication
(10) Pub. No.: US 2025/0007327 A1
(43) Pub. Date: Jan. 2, 2025

(54) CRYOGENIC ENERGY STORAGE SYSTEMS AND METHODS OF OPERATING THE SAME

(71) Applicant: University of Kwa-Zulu Natal, Westville (ZA)

(72) Inventor: Alan Lawrence Leigh Jarvis, Westville (ZA)

(21) Appl. No.: 18/703,156

(22) PCT Filed: Oct. 20, 2022
(86) PCT No.: PCT/IB2022/060104

§ 371 Date: Apr. 19, 2024

(30) Foreign Application Priority Data
Oct. 20, 2021 (NL) 2029478

(51) Int. Cl. H02J 15/00; F17C 3/02

(52) U.S. Cl. CPC H02J 15/00; F17C 3/02; F17C 2223/0161; F17C 2227/0135; F17C 2250/0408; F17C 2250/043; F17C 2250/0439; F17C 2270/0527

(57) ABSTRACT

The invention relates to a cryogenic energy storage system (CESS), particularly to a hybrid CESS which includes superconducting electrical based components, devices and systems therein requiring access to cryogenic temperatures to function. The CESS includes a cryogen storage facility such as a tank or cylinder filled with a cryogen, such as liquid air. A cryogen expansion arrangement is provided to the CESS to expand stored cryogen from the cryogen storage facility, in use; and an energy generating arrangement is provided to use expanding cryogen from the cryogen expansion arrangement to generate electrical energy, in use. A superconducting system, comprising a superconducting device, is embedded in the cryogen storage facility in order to function at a desired operating temperature having no or little influence on the cryogenic energy storage system (CESS).

### CROSS-REFERENCE TO RELATED APPLICATIONS

This application is a national phase application of, and claims priority to, International Patent Application No. PCT/IB2022/060104, filed on Oct. 20, 2022, which claims the benefit of Netherlands Patent Application Serial No. 2029478, filed Oct. 20, 2021, the disclosures of which is are incorporated by reference herein in their entireties.

### TECHNICAL FIELD

This application relates to Cryogenic Energy Storage Systems (CESS), including Liquid Air Energy Storage (LAES), Liquid Air Battery (LAB), and the like.

### BACKGROUND

Cryogenic Energy Storage Systems (singular, CESS) are energy storage systems which store energy in the form of cryogenic liquids, referred to herein also as “cryogens”, at low temperatures for subsequent expansion, as and when required, to drive suitable turbine/s to produce electrical energy. CESSs are scalable and can store large amounts of energy (>250 MW·h) in an environmentally friendly manner since cryogenic liquid in the form of liquid air is usually benign, portable, and non-polluting. In this way, CESSs provides an environmentally friendlier option to store energy and generate electrical energy when required as opposed to fossil fuel combusting technologies such as petroleum or diesel generators.

There are typically three stages or parts to a CESS, (i) liquefaction of gaseous cryogen such as air with use of electrical energy, (ii) storage of liquid air in tanks and (iii) the expansion of liquid air which drives turbines to generate electrical energy as shown below:

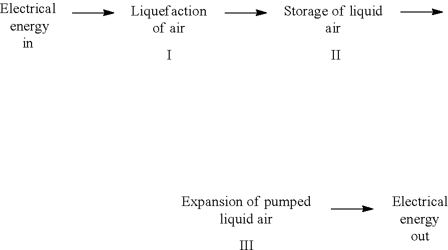

In summary, a CESS uses electricity (may be renewable based) to cool a cryogen gas such as air until it liquefies. This liquid air is stored in an appropriate tank. The liquid cryogen turns into a kinetic gaseous state when exposed to ambient air or with waste heat, the energised gas turns a turbine and generates electricity.

The Inventor has identified that CESSs, as well as other technologies which require low temperatures to operate or efficiently function (in the range which cryogen in the form of liquid air is in a liquid state) may be optimised or enhanced by incorporating said technologies with CESSs, particularly parts thereof, in a mutually beneficial or synergistic fashion.

### SUMMARY

According to a first set of embodiments of the invention, there is provided a cryogenic energy storage system comprising:
a cryogen storage facility storing or configured for storing a cryogen;
a cryogen expansion arrangement configured to expand cryogen received from the cryogen storage facility, in use;
an energy generating arrangement configured to be powered by expanding cryogen from the cryogen expansion arrangement to generate electrical energy, in use; and
a superconducting device, located in the cryogen storage facility such that the superconducting device is cooled by the cryogen stored in the cryogen storage facility.

The cryogen stored in the cryogen storage facility may be liquid air or nitrogen. Liquid air is mostly comprised of liquid nitrogen (78%). In this regard, the cryogen storage facility may maintain the cryogen therein at a temperature of approximately 78.8 K, between the boiling point of liquid nitrogen (77.36 K) and liquid oxygen (90.19 K), and at one atmospheric pressure. It will be understood that the temperature of the cryogen may be maintained at a temperature not greater than the boiling point of the cryogen (approximately 78.8 K in the case of the cryogen being in the form of liquid air), and greater than the freezing point of the cryogen (58.0 K in the case of the cryogen being in the form of liquid air or 63.1 K in the case of liquid nitrogen).

The superconducting device may be a high temperature superconducting device and/or may comprise or may be constructed from superconducting material. In this regard, the superconducting system/device is configured to operate at higher cryogenic temperatures of around 78 K (−197° C.) which may be the approximate temperature at which the cryogen in the cryogen storage facility is stored at. It follows that the temperature of the cryogen in the cryogen storage facility is conveniently below a critical temperature (Tc) of superconducting/superconductor material present in the superconducting device or from which the superconducting/superconductor device is composed of. In this way, the need for, and costs associated with, a dedicated superconductor device cooling system is conveniently obviated as the presence of the superconducting device in the cryogen storage facility will generate little excess cryogen boil-off and appear thermally transparent to the cryogen tank since most superconducting devices generate little or no heat due to the superconducting property of zero resistance.

The superconducting device may be selected from a group comprising a superconducting magnet energy storage (SMES) device, a superconducting transformer (ST), and a superconducting fault current limiter (SFCL). It will be noted that in some example embodiments, the superconducting system may comprise more than one superconducting device, for example, selected from the above group of superconducting devices.

The superconducting device may be maintained at an operational temperature below Tc by the cryogen storage facility which reduces costs and complexity of providing dedicated cooling systems therefor.

The SMES device may be configured to generate electrical energy instead of, or in addition to, the electrical energy generated by the energy generating arrangement. In particular, the SMES device may be configured to provide power to a load operatively connected to the cryogenic energy storage system prior to the energy generating arrangement providing power to said load. This serves to address uses such as load levelling and balance short duration transient faults due to its high power response as described herein. In some example embodiments, the electrical energy generated by the energy generating arrangement may be used to charge the SMES device.

The SFCL may be electrically coupled to an electrical power grid and to a load, wherein the SFCL may be configured to limit fault currents from the grid reaching the load. Similarly, the ST may be electrically coupled to an electrical power grid and/or a load.

In one example embodiment, the cryogen storage facility may comprise a suitable cryogen storage tank storing or configured for storing the cryogen and housing at least the superconducting device therein. In this regard, it will be noted that the superconducting system, particularly the superconducting device, may be embedded in the cryogen storage tank.

The cryogenic energy storage system may comprise:
a memory device;
a processor coupled to the memory device; and
one or more sensors operatively arranged in the cryogen storage tank operatively connected to the processor to measure one or more parameters and transmit data indicative of the same to the processor, wherein the processor is configured to activate a suitable alarm protocol in response to determining that one or more measured parameters is unacceptable.

In particular, the system may comprise a suitable level sensor communicatively coupled to the processor to measure an amount of cryogen stored in the cryogen storage tank, wherein the processor is configured to activate a suitable alarm protocol in response to determining that the amount of cryogen in the cryogen storage tank, measured by way of the level sensor, falls below a minimum operating amount/level/volume of cryogen required for the superconducting device. In this way, the cryogen in the cryogen storage tank may be used to generate electrical energy by way of the energy generating arrangement but not to an amount or extent which will affect cooling of the superconducting device as described herein. It follows that the minimum operating amount/level/value of cryogen required for the superconducting device is an amount of cryogen required to suitably cool the superconductor device such that it is maintained and/or operating in a superconducting state.

The system may comprise a suitable vibration sensor communicatively coupled to the processor to sense vibration of, or in, the cryogen storage tank, wherein the processor is configured to activate a suitable alarm protocol in response to determining that the vibration sensed, by way of the vibration sensor, is not acceptable. The vibration sensor may be a conventional piezoelectric senor vibration sensor. The superconducting devices may be triggered into a quench event based on vibrations exceeding a threshold.

The system may comprise a suitable pressure sensor communicatively coupled to the processor to measure the pressure in the cryogen storage tank, wherein the processor is configured to activate a suitable alarm protocol in response to determining that the pressure in the cryogen storage tank, measured by way of the pressure sensor, is not acceptable. The cryogen storage tank may comprise a suitable valve for boil off of cryogen. The cryogen storage tank may further comprise a second valve to cope with generation of excess vapour in case of an over pressure event, such as a quench, detected by the processor. The processor may be configured to control the valves. In the event of the processor determining that the measured pressure exceeds a maximum pressure, the processor may be configured to activate the alarm protocol by at least disconnecting/purging energy to/from the superconducting device.

The system may comprise a temperature sensor communicatively coupled to the processor to measure temperature of the cryogen stored in the cryogen storage tank, wherein the processor is configured to activate a suitable alarm protocol in response to determining that the temperature of the cryogen in the cryogen storage tank, measured by way of the temperature sensor, falls outside of a predetermined temperature range. The system may comprise a plurality of temperature sensors to sense/measure the temperature of the cryogen stored and/or the cryogen storage tank, particularly the homogeneity of the temperature of the cryogen. As alluded to herein, in the case of the cryogen being liquid air, the predetermined temperature range is above the freezing point of liquid air, for example, 58.0 K but less than the boiling point of liquid air, for example, 78.8 K. It will be noted that the alarm protocol, should the measured temperature not be within the predetermined temperature range, may comprise disconnecting/purging energy to/from the superconducting device, if necessary, in order to negate a critical superconductor quench event.

In summary, part of the alarm protocol as contemplated herein may comprise one or more of disconnecting/purging energy to/from the superconducting device, and generating a suitable alarm signal to actuate a suitable alarm device. The suitable alarm device may be a siren, light, or the like to alert operators of the system and/or maintenance personnel.

In one example embodiment, the system may comprise a suitable vacuum pump operatively connected to the cryogen storage tank, wherein the suitable alarm protocol comprises operating the vacuum pump to reduce vapour pressure in the cryogen storage tank, thereby reducing the temperature of the cryogen in the cryogen storage tank to bring the temperature within the predetermined temperature range. This may be done in response to the temperature measured by way of the temperature sensor/s falling outside, typically above the range contemplated herein for the cryogen in the cryogen storage tank.

To ensure a homogenous temperature of the cryogen in the cryogen storage tank, the cryogen storage tank may comprise a suitable agitator, such as a stirrer, located therein so as to at least to maintain a homogenous temperature in the cryogen storage tank. It will be understood that the processor may be configured to operate the stirrer in response to determining that the temperature distribution of cryogen in the cryogen storage tank is not homogenous. Instead, or in addition, the processor may be configured to operate the stirred periodically, for example, at predetermined time intervals to ensure homogeneity of temperature of the cryogen in the cryogen storage tank.

In one example embodiment, the cryogen storage facility may comprise one or more primary cryogen storage tank/s configured for storing or storing the cryogen; and at least one secondary cryogen storage tank storing or configured for storing the cryogen and housing the superconducting device. It follows that the secondary cryogen storage tank may be the cryogen storage tank storing or configured for storing the superconducting device as hereinbefore described, wherein the primary storage tank/s stores cryogen for use by the energy generating arrangement to generate electrical energy and optionally to top up the secondary cryogen storage tank with cryogen. The primary and secondary cryogen storage tanks may be in controlled fluid communication with each other.

It will be noted that in the last mentioned example embodiment, the primary cryogen storage tank typically supplies the cryogen to the cryogen expansion arrangement, whereas the secondary cryogen storage tank is configured to house the superconducting system. For brevity, the terms “primary tank” and “primary cryogen storage tank” may be used interchangeably herein. Similarly, the terms “secondary tank” and “secondary cryogen storage tank” may be used interchangeably herein.

All the cryogen storage tanks described herein may be thermally insulated cryogen storage tanks.

The secondary storage tank may receive cryogen from the primary storage tank and may be configured to maintain cryogen therein at a lower temperature than the primary storage tank. To this end, the system may comprise a suitable pump to transport cryogen between the primary cryogen storage tank and the second cryogen storage tank. The pump may be operatively located in or adjacent to the primary cryogen storage tank to pump cryogen from the primary cryogen storage tank to the secondary cryogen storage tank so as to maintain a predetermined minimum operating amount/level/volume of cryogen in the secondary cryogen storage tank.

The system as described herein may comprise a suitable processor communicatively coupled to the pump to control the same to pump cryogen from the primary cryogen storage tank to the secondary cryogen storage tank upon detecting that the cryogen levels in the secondary cryogen storage tank is below the predetermined minimum operating amount/level. To this end, the secondary cryogen storage tank may comprise a suitable level sensor to sense the level or volume of cryogen in the secondary cryogen storage tank.

The system may comprise a suitable temperature reducing assembly configured to reduce the temperature of the cryogen in the secondary cryogen storage tank. In one example embodiment, the temperature reducing assembly may comprise preferably a vacuum pump configured to reduce vapour pressure in the secondary cryogen storage tank, wherein operation of the vacuum pump causes a reduction of the temperature of the cryogen in the secondary cryogen storage tank.

In one example embodiment, the secondary tank may comprise a suitable temperature sensor operatively coupled to the processor and configured to sense the temperature of the cryogen in the secondary tank, wherein the processor is configured to operate the vacuum pump in response to determining, via the temperature sensor, that the temperature of the cryogen in the secondary cryogen storage tank is not within a desired temperature range or above a predetermined temperature threshold.

The secondary cryogen storage tank may be pneumatically isolated from the primary cryogen storage tank when the vacuum pump is operated. This may be achieved by way of suitable valve/s provided in a fluid flow path provided between the primary cryogen storage tank and the secondary cryogen storage tank.

In one example embodiment, the primary cryogen storage tank may be one of a plurality of primary cryogen storage tanks. Similarly, the secondary cryogen storage tank may be one of a plurality of secondary cryogen storage tanks. In one example embodiment, the primary storage tank may have a capacity of approximately 2000 litres of cryogen. One or both the primary and the secondary cryogen storage tanks may be constructed wholly, or in part, from a non-metallic material so as at least to reduce any induction heating of the vessel.

The cryogen expansion arrangement may comprise a suitable heat exchanger. The heat exchanger may be configured to heat the cryogen using heat from one or more of ambient air, geothermal heat, waste heat from a power plant, and waste heat from a manufacturing plant in order to expand the same.

The energy generating arrangement may comprise:
a turbine configured to be driven by the expanding cryogen from the cryogen expansion arrangement, in use; and
a generator configured to be actuated by the turbine thereby to generate electrical energy, in use.

In one example embodiment, the system may comprise an air liquification arrangement configured to liquefy air and store the same in the cryogen storage facility. In one example embodiment, the air liquification arrangement may be configured to supply liquified air for storage in the primary cryogen storage tank.

According to a second set of embodiments of the invention, there is provided a method of operating a cryogenic energy storage system, wherein the method comprises:
storing a cryogen in a cryogen storage facility;
expanding the stored cryogen received from the cryogen storage facility;
generating electrical energy by using the expanded cryogen to actuate a suitable energy generating arrangement;
providing a superconducting device, in the cryogen storage facility; and
cooling the superconducting device with the cryogen stored in the cryogen storage facility.

The cryogenic energy storage system may be similar to the system as described herein thus descriptions relating thereto apply mutatis mutandis to the summary of any of the methodologies for operating such cryogenic energy storage system described herein.

The method may comprise operating the SMES to generate electrical energy instead or in addition to the electrical energy generated by the energy generating arrangement. The method further comprises charging the SMES device with electrical energy generated by the energy generating arrangement, in use.

The method may comprise operating the SMES device to provide power to a load operatively connected to the cryogenic energy storage system prior to the energy generating arrangement providing power to said load.

The method may comprise:
measuring one or more parameters associated with the cryogen storage tank and/or the cryogen stored therein;
transmitting the measured parameters to a suitable processor communicatively coupled to a suitable memory device; and
activating a suitable alarm protocol in response to determining that one or more measured parameters is unacceptable.

The method may comprise measuring an amount of cryogen stored in the cryogen storage tank, and activating a suitable alarm protocol, by way of the processor, in response to determining that the amount of cryogen in the cryogen storage tank falls below a minimum operating amount of cryogen required for the superconducting device stored therein.

The method may comprise sensing or measuring vibration of, or in, the cryogen storage tank, and activating a suitable alarm protocol, by way of the processor, in response to determining that the vibration sensed is not acceptable.

The method may comprise measuring pressure in the cryogen storage tank and activating a suitable alarm protocol, by way of the processor, in response to determining that the pressure measured is not acceptable.

The method may comprise measuring temperature of the cryogen stored in the cryogen storage tank and activating a suitable alarm protocol, by way of the processor, in response to determining that the temperature of the cryogen in the cryogen storage tank falls outside of a predetermined temperature range.

The suitable alarm protocol may comprise operating a vacuum pump operatively connected to the cryogen storage tank to reduce vapour pressure in the cryogen storage tank, thereby reducing the temperature of the cryogen in the cryogen storage tank to bring the temperature within the predetermined temperature range.

The predetermined temperature range may be bound by a temperature not greater than the boiling point of the cryogen, and greater than the freezing point of the cryogen.

The method may comprise operating a suitable agitator in the cryogen storage tank so as to at least to maintain a homogenous temperature in the cryogen storage tank.

The cryogen storage facility may comprise:
one or more primary cryogen storage tank/s storing or configured to store the cryogen; and
at least one secondary cryogen storage tank storing or configured to store the cryogen, wherein the primary and secondary cryogen storage tanks are in controlled fluid communication with each other, and wherein the secondary cryogen storage tank houses the superconducting device, wherein the method comprises transporting cryogen from the primary cryogen storage tank to the secondary cryogen storage tank in response to detecting that a level of cryogen in the secondary cryogen storage tank is below a predetermined threshold and/or transporting cryogen from the secondary cryogen tank to the primary cryogen tank up to a minimum volume of cryogen required in the secondary tank required for the superconducting device.

The method may comprise reducing vapour pressure in the secondary cryogenic storage tank by operating a suitable vacuum pump operatively connected to the secondary tank as described herein.

The method may comprise maintaining the temperature of the cryogen in the primary cryogen storage tank less than or equal to the boiling point of the cryogen. The method may comprise maintaining the temperature of the cryogen in the secondary cryogen storage in a temperature range less than the boiling point of the cryogen and greater than the freezing point of the cryogen.

According to a third set of embodiments of the invention, there is provided a cryogen storage facility storing or configured to store a cryogen, wherein the cryogen storage facility comprises a superconducting device therein such that the superconducting device is cooled by the cryogen stored in the cryogen storage facility.

The cryogen storage facility may be substantially similar to the cryogen storage facility described herein.

According to a fourth aspect of the invention there is provided a method of cooling a superconducting device, wherein the method comprises:
locating the superconducting device in a cryogen storage facility associated with a cryogen energy storage system; and
cooling the superconducting device with the cryogen stored in the cryogen storage facility.

It will be appreciated by those skilled in the art that the description provided herein relating to one set of embodiments of the invention may extend/apply, mutatis mutandis, to other sets of embodiments of the invention described herein.

### BRIEF DESCRIPTION OF THE DRAWINGS

FIG. 1 shows a high-level schematic block diagram of a Cryogenic Energy Storage System in accordance with an example embodiment of the invention.

FIG. 2 shows a schematic diagram of a cryogen storage facility comprising a cryogen storage tank with a superconducting device embedded therein in accordance with an example embodiment of the invention.

FIG. 3 shows a schematic diagram of another example of a cryogen storage facility comprising a primary cryogen storage tank and a secondary cryogen storage tank with a superconducting device embedded therein in accordance with an example embodiment of the invention.

### DETAILED DESCRIPTION

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features.

Accordingly, those skilled in the art will recognise that modifications and adaptations to the present invention are possible, and may even be desirable in certain circumstances, and are a part of the present invention. Thus, the following description is provided as illustrative of the principles of the present invention and not a limitation thereof.

It will be appreciated that the phrase “for example,” “such as”, and variants thereof describe non-limiting embodiments of the presently disclosed subject matter. Reference in the specification to “one example embodiment”, “another example embodiment”, “some example embodiment”, or variants thereof means that a particular feature, structure or characteristic described in connection with the embodiment(s) is included in at least one embodiment of the presently disclosed subject matter. Thus, the use of the phrase “one example embodiment”, “another example embodiment”, “some example embodiment”, or variants thereof does not necessarily refer to the same embodiment(s).

Unless otherwise stated, some features of the subject matter described herein, which are, described in the context of separate embodiments for purposes of clarity, may also be provided in combination in a single embodiment. Similarly, various features of the subject matter disclosed herein which are described in the context of a single embodiment may also be provided separately or in any suitable sub-combination.

The headings used herein are for organizational purposes only and are not meant to be used to limit the scope of the description or the claims. For brevity, the word “may” is used in a permissive sense (i.e., meaning “having the potential to”), rather than the mandatory sense (i.e., meaning “must”).

The words “include,” “including,” and “includes” and the words “comprises”, “comprising”, and “comprises” mean including and comprising, but not limited thereto, respectively. Additionally, as used herein, the term “coupled” may refer to two or more components connected together, whether that connection is permanent (e.g., welded, cast, moulded, carved) or temporary (e.g., bolted, screwed, adhered via an adhesive), direct or indirect (i.e., through an intermediary), mechanical, chemical, optical, or electrical as is the case in a communicatively coupled components which may be in communication with each other wirelessly or in a hardwired fashion.

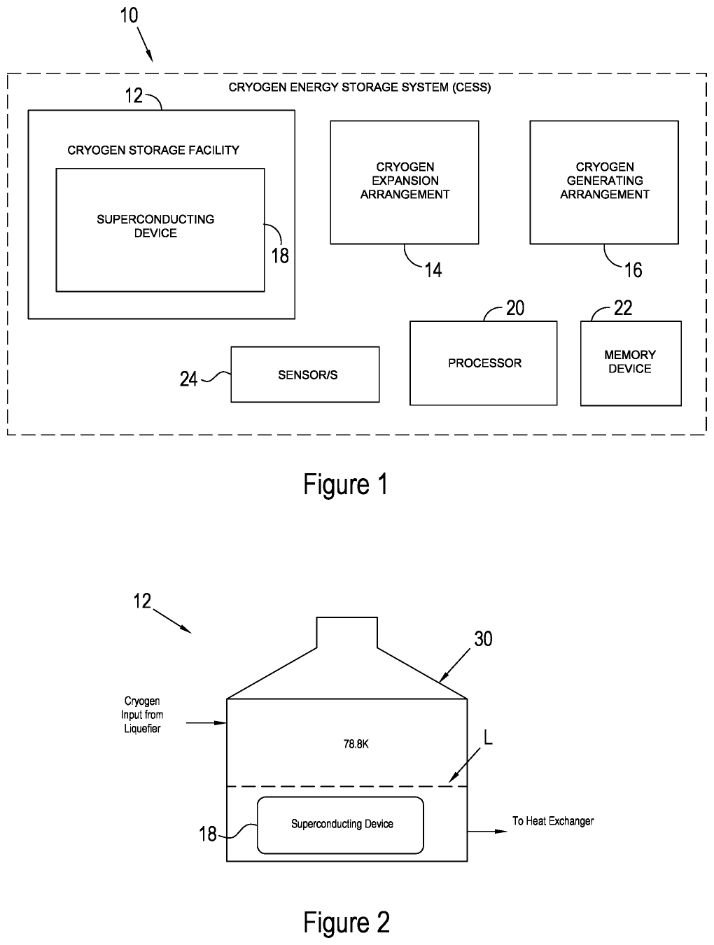

Referring to FIG. 1 of the drawings, there is provided a cryogenic energy storage system (CESS) generally indicated by reference numeral 10. The CESS 10 is typically a hybrid CESS used to store energy which may be released therefrom in the form of electrical energy to power one or more loads operatively connected to the CESS 10. To this end, the CESS 10 may be used as a back-up electrical energy generator to supply electrical energy to the load/s in the event that other energy sources such as municipal electrical grids are not available/offline. Instead, or in addition, the CESS 10 is configured to supply cheaper or greener electrical energy to a load with/without being connected to a municipal electrical grid. To this end, the CESS 10 may comprise various power electronic component/s, device/s and apparatus/es (not shown) to enable the same to be interfaced with said load/s and/or the electrical grid.

In a preferred example embodiment, the CESS 10, or parts thereof is located adjacent a source of waste heat from a manufacturing/industrial process such as a factory, or the like, which generates heat which is otherwise lost.

The CESS 10 comprises a cryogen storage facility 12 storing or configured for storing a cryogen, for example, liquid air which is comprised primarily of nitrogen. Though other cryogenic material/s may be used as the stored cryogen, reference will be made to an example embodiment whereby the cryogen is liquid air though the terms “cryogen” and “liquid air” may be used interchangeably herein. Though not shown, the CESS 10 may comprise or may be in communication with a suitable air liquification system which may be employed to liquefy air to be stored in the storage facility 12.

The CESS 10 also comprises a cryogen expansion arrangement 14 having a suitable heat exchanger (not shown) to expand the stored cryogen, and an energy generating/generation arrangement 16 configured to be powered by expanding cryogen from the cryogen expansion arrangement 14 to generate electrical energy, in use. Though not illustrated, the energy generating arrangement 16 may comprise a suitable turbine and a suitable generator, wherein the turbine is configured to be driven by expanding cryogen from the expansion arrangement 14, wherein the turbine drives the generator to generate electrical energy in a conventional fashion.

The CESS 10 and particularly at least the cryogen expansion arrangement 14 may be located near a source of waste heat as described herein.

The CESS 10 further comprises a superconducting device 18 located in the cryogen storage facility such that the superconducting device 18 is cooled by the cryogen stored in the cryogen storage facility 12. In this way, the need for a dedicated an expensive cooling system associated with the superconducting device 18 is obviated.

The superconducting device 18 may be a device comprising or manufactured from superconducting material/s. In this regard, the superconducting device may be selected from a group comprising a superconducting magnet energy storage (SMES) device, superconducting electronics, a superconducting transformer (ST), and a superconducting fault current limiter (SFCL).

For ease of explanation, reference will be made to the superconducting device 18 being in the form of a SMES device 18. However, it will be appreciated by those skilled in the art that the principles taught herein may apply mutatis mutandis to other superconducting devices and/or components.

The SMES device 18 is typically configured to store and output electrical energy, on demand, instead of, or in addition to, the electrical energy generated by the energy generating arrangement. Compared to the CESS the SMES device 18 is typically a high power, low energy device and thus the SMES device 18 is configured to provide power to a load operatively connected to the CESS 10 prior to the energy generating arrangement 16 providing power to said load. In other words, the SMES device 18 is configured to deliver electrical energy to the load relatively quickly whilst the energy generating arrangement 16 starts up to deliver electrical energy to the load.

The SMES device 18 is typically stored in the cryogen storage facility 12. In particular, with reference to FIG. 2 of the drawings as well, the SMES device 18 is conveniently located in a cryogen storage tank 30 of the cryogen storage facility. As alluded to herein, the SMES device 18 is conveniently cooled by the cryogen in the tank 30 to a temperature not exceeding 78.8 K so as to prevent boil off of the liquid air and/or support the cooling of the SMES device 18 to within the desired parameters. In some example embodiment, the CESS 10 may comprise a suitable vacuum pump (not shown) to further reduce the temperature of the cryogen in the cryogen storage tank 30 to a temperature just above freezing temperature thereof, typically above 58 K.

The tank 30 may be constructed, or a majority of the tank 30 may be constructed, from non-metallic material/s. Moreover, the tank 30 may be thermally insulated, for example, by way of a suitable thermal jacket and may be sealed save for the ports/valves contemplated herein. In one example embodiment, the tank may be a 2000 litre tank storing or configured for storing liquid air cryogen, wherein the tank has a predetermined minimum level L of cryogen to be stored therein to adequately cool the superconducting device 18.

The tank 30 may comprise suitable vents and/or the like as well as inlet ports and/or outlet ports (not shown) for the inlet and outlet of liquid air cryogen to and from the tank 30.

The CESS 10 conveniently comprises a sensor arrangement comprising one or more sensors 24 (FIG. 1) disposed in and/or around the tank 30 same to measure and/or sense various parameters associated with the tank 30, particularly the cryogen stored therein. To this end, the CESS 10 as described herein comprises a suitable processor 20 communicatively coupled to a suitable memory device 22 as well as the sensor/s 24 to receive the measured and/or sensed parameters and/or information indicative of the same.

The processor 20 may typically be one or a combination of microcontrollers, processors, graphics processors, or field programmable gate arrays (FPGAs) operable to achieve the desired operation as described herein. The processor 20 may be operable under instructions stored in an internal memory or external memory device 22 to perform the operations described herein.

The processor 20 is typically configured to activate a suitable alarm protocol in response to determining that one or more measured parameters is unacceptable. In this regard, the CESS 10 comprises a suitable level sensor (not shown) communicatively coupled to the processor 20 to measure or monitor an amount of cryogen stored in the cryogen storage tank 30. In particular, the processor 20 is configured to activate a suitable alarm protocol in response to determining that the level of cryogen in the cryogen storage tank, measured by way of the level sensor, falls below the minimum operating level L of cryogen required for the superconducting device 18. In this way, the cryogen stored in the tank 30 may be used to generate electrical energy by way of the arrangements 14 and 16 but the tank 30 is never emptied of cryogen to a level wherein it would impact on the ability of the cryogen stored in the tank to sufficiently cool the superconducting device 18.

In some example embodiments, the CESS 10 comprises a suitable vibration sensor (not shown) communicatively coupled to the processor 20 to sense vibration of, or in, the cryogen storage tank 30. The processor 20 is configured to activate a suitable alarm protocol in response to determining that the vibration sensed, by way of the vibration sensor, is not acceptable. In this way, the integrity of the CESS 10 may be preserved.

In some example embodiments, the CESS 10 comprises a suitable pressure sensor communicatively coupled to the processor 20 to measure the pressure in the cryogen storage tank 30. The processor 20 is configured to activate a suitable alarm protocol in response to determining that the pressure in the cryogen storage tank, measured by way of the pressure sensor, is not acceptable.

The CESS 10 conveniently comprises a plurality of temperature sensors (not shown) communicatively coupled to the processor 20 to measure temperature of the cryogen stored in the cryogen storage tank. The temperature sensors may be disposed at various locations within the cryogen storage tank 30 to measure at least the homogeneity of the cryogen stored therein. It will be appreciated that the processor 20 is configured to activate a suitable alarm protocol in response to determining that the temperature of the cryogen in the cryogen storage tank, measured by way of the temperature sensor, falls outside of the predetermined temperature range or setpoint, for example, if the temperature goes beyond 78.8 K. In this regard, if the processor 20 determines that the temperature of the cryogen in the tank 30 is increasing beyond 78.8 K, the processor 20 is configured to operate the suitable vacuum pump as mentioned above to reduce vapour pressure in the cryogen storage tank 30, thereby reducing the temperature of the cryogen in the cryogen storage tank 30 to bring the temperature within the predetermined temperature range or within the setpoint of 78.8 K.

It will be noted that the alarm protocol includes one or more of disconnecting/purging energy to/from the superconducting device 18, and generating a suitable alarm signal to actuate a suitable alarm device such as a siren, etc.

In one example embodiment, the cryogen storage tank 30 comprises a suitable agitator, such as a stirrer, (not shown) controllable by the processor 20 so as to at least to maintain a homogenous temperature in the cryogen storage tank 30.

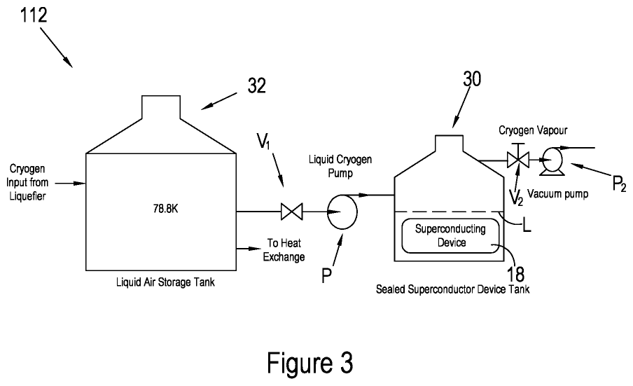

Referring now to FIG. 3 of the drawings, where another example embodiment of the storage facility 112 in accordance with an example embodiment of the invention is illustrated. The storage facility 112 illustrated in FIG. 3 comprises a cryogen storage tank 30 which is similar to the tank 30 described above with reference to FIG. 2 and thus similar parts will be referred to by the same reference numerals. However, the storage facility 112 comprises a primary cryogen storage tank 32 storing or configured for storing the cryogen in selective fluid communication with the tank 30, the latter may be referred to herein as a secondary tank 30. It will be noted that the primary tank 32 may be similar to the tank 30 but does not house a superconducting device 18 therein and is primarily used to store cryogen primarily for purposes of operating the arrangements 14 and 16, and optionally top up cryogen in the tank 32. The tank 30 on the other hand is used to house the superconducting device 18 and/or optionally store cryogen for use by the arrangements 14 and 16, up to the predetermined level L. Though only one primary and one secondary tank 30, 32 is illustrated, it will be appreciated that the facility 112 may have a plurality of primary tanks 32 and optionally more than one secondary tank 30 storing or configured for storing a superconducting device 18 therein.

It will be noted that the CESS may comprise a suitable pump P and valve V1 disposed between the tanks 30 and 32 to control flow of cryogen from the primary tank 32 to the secondary tank 30, when required. In one example embodiment, the processor 20 is configured to operate the pump P and the valve V1 to transport cryogen from the tank 32 to the tank 30, for example, when the processor 20 determines, by way of the level sensor, for example, a capacitance level sensor, that the level of cryogen in the tank 30 is below the predetermined minimum level L.

As mentioned above, and as illustrated in FIG. 3, the CESS 10 comprises a suitable vacuum pump Pv and a valve V2, wherein the processor 20 is configured to operate the vacuum pump Pv, and optionally operate the valve V2, to reduce the temperature of the cryogen in the tank 30 to be within the predetermined temperature range, for example, 58 K<T<78K by reducing the vapour pressure within the tank 30.

In use, referring to FIGS. 1 to 3 of the drawings, the CESS 10 stores cryogen at a temperature below 78 K in the storage facility 12, 112, particularly the tanks 30, 32. In addition, the CESS 10 houses the superconducting device such as the SMES device 18 in one of the tanks 30.

When power is required by a load, the CESS 10 is operated such that the SMES 18 is actuated simultaneously with the release of cryogen to the expansion arrangement 14 and energy generating arrangement 16. However, due to the high power nature of the SMES device 18, the SMES device 18 provides power to the load before the energy generating arrangement 16 thus substantially decreasing any lag in supply of electrical energy to the load associated with the arrangement 16 in certain scenarios depending on load demands. In some example embodiments, it will be noted that the SMES device 18 may be operated to provide power to the load without the CESS 10 being operated to produce electrical energy through the release of cryogen to the expansion arrangement 14 and operation of the energy generating arrangement 16.

In the case of the facility 112, cryogen is typically utilised from the primary tank/s 32. However, should the need arise, or alternately in the case of the storage facility 12 comprising only the tank 30, cryogen is typically outlet from the tank 30 to the expansion arrangement 14 to power the energy generation arrangement 16. However, the processor 20 monitors the level of cryogen in the tank 30 by way of the level sensor. Should the processor 20 determine that the level of cryogen in the tank 30 is at or below the predetermined minimum level L, the processor 20 may be configured to operate the pump P and valve V1 to top up the cryogen in the tank 30.

Moreover, the processor 20 controls the stirrer in the tank 30 to ensure that the temperature distribution is homogenous. However, if the processor 20 determines, by way of the temperature sensor, that the temperature in the tank 30 is not homogenous and/or the stirrer is not working, the processor 20 activates a suitable alarm protocol to indicate that the stirrer is not operational. Similarly, alarm protocols may be activated by the processor 20 in response to determining via suitable sensors 24 that the pressure in the tank 30 or vibration sensed in/of the tank 30 is unacceptable.

In one example embodiment, if the processor 20 determines that the temperature of the cryogen in the tank 30 is above a set temperature value, Ts, which lies between the cryogen freezing point and cryogen boiling point (58 K<Ts<78 K) t, the processor 20 is configured to operate the vacuum pump Pv and optionally the valve V2 to reduce the vapour pressure in the tank 30 thus reducing the temperature of the cryogen in the tank 30. In the case of the facility 112, the vacuum pump Pv may be operated to bring the temperature of the cryogen therein between 58 K and 78 K.

Liquid air may be supplied to the storage facility 12, 112 by way of a suitable liquid air liquification system.

The resulting hybrid system as described herein seeks to reduces the capital and running cost of an independent cryogenic cooling system required for the superconducting devices/systems. Pumping on a cryogen storage facility (tank) by way of the vacuum pump reduces the vapour pressure and results in reducing the temperature of the cryogen; which results in the increase of performance of superconducting devices in the tanks which house the same.

A 100% green electrical supply is realised if a CESS is charged by renewable energy sources, such as Photovoltaic (PV) or wind turbines. In this regard, in some example embodiments, the CESS may be charged by a renewable energy source.

Voltage and power fluctuations in power systems can result from different events, for example, clouds passing over a PV farm can affect solar irradiance received by the PV farm. These fluctuation have a negative impact on loads connected directly to the PV, for example (i) causing changes in electrical machines torque, which leads to vibrations and deterioration of machine and (ii) uninterruptible power sources (UPS) where utilisation of the UPS batteries for short events impacts on the longevity of the batteries.

A CESS with energy stored as a cryogen intrinsically can accommodate the required operating temperatures of a SMES. This hybrid CESS/SMES system is well suited to mitigate power fluctuations such as mentioned above with a SMES power response, and for longer power outage durations with use of the CESS, for example when there is no electrical energy produced from PV farm (night-time).

The embodiments described above are only descriptions of preferred embodiments of the present invention, and are not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

### APPENDIX

Example 1: A cryogenic energy storage system comprising:
a cryogen storage facility storing or configured for storing a cryogen;
a cryogen expansion arrangement configured to expand cryogen received from the cryogen storage facility, in use;
a suitable energy generating arrangement configured to be powered by expanding cryogen from the cryogen expansion arrangement to generate electrical energy, in use; and
a superconducting device, located in the cryogen storage facility such that the superconducting device is cooled by the cryogen stored in the cryogen storage facility, in use.

Example 2: The cryogenic energy storage system of Example 1, wherein the cryogen expansion arrangement comprises a suitable heat exchanger.

Example 3: The cryogenic energy storage system of Example 2, wherein the heat exchanger is configured to heat the cryogen using heat from one or more of ambient air, geothermal heat and, industrial waste heat from a power plant, and waste heat from a manufacturing plant.

Example 4: The cryogenic energy storage system of Example 1, wherein the energy generating arrangement comprises:
a turbine configured to be powered by the expanding cryogen from the cryogen expansion arrangement, in use; and
a generator configured to be actuated by the turbine thereby to generate electrical energy, in use.

Example 5: The cryogenic energy storage system of Example 1, wherein the cryogen is one of liquid air, or liquid nitrogen.

Example 6: The cryogenic energy storage system of Example 5, wherein the system comprises a liquefaction arrangement configured to liquefy a gas and store the same as the cryogen in the cryogen storage facility.

Example 7: A method of operating a cryogenic energy storage system, wherein the method comprises:
storing a cryogen in a cryogen storage facility;
expanding the stored cryogen received from the cryogen storage facility;
generating electrical energy by using the expanded cryogen to actuate a suitable energy generating arrangement;
providing a superconducting device, in the cryogen storage facility; and
   cooling the superconducting device with the cryogen stored in the cryogen storage facility.

Example 8: The method of Example 7, wherein the superconducting device is selected from a group comprising a superconducting magnet energy storage (SMES) device, a superconducting transformer (ST), superconducting electronics, and a superconducting fault current limiter (SFCL).

Example 9: The method of Example 8, wherein the method comprises operating the SMES to generate electrical energy instead or in addition to the electrical energy generated by the energy generating arrangement.

Example 10: The method of Example 9, wherein the method comprises charging the SMES device with electrical energy generated by the energy generating arrangement, in use.

Example 11: The method of Example 8, wherein the method comprises operating the SMES device to provide power to a load operatively connected to the cryogenic energy storage system prior to the energy generating arrangement providing power to said load.

Example 12: The method of Example 8, wherein the SFCL is electrically coupled to an electrical power grid and to a load, wherein the method comprises limiting fault currents from the grid reaching the load by way of the SFCL.

Example 13: The method of Example 7, wherein the cryogen storage facility comprises a suitable thermally insulated cryogen storage tank storing or configured for storing the cryogen and housing the superconducting device therein.

Example 14: The method of Example 13, wherein the method comprises:
measuring one or more parameters associated with the cryogen storage tank and/or the cryogen stored therein;
transmitting the measured parameters to a suitable processor communicatively coupled to a suitable memory device; and
activating a suitable alarm protocol in response to determining that one or more measured parameters is unacceptable.

Example 15: The method of Example 14, wherein the method comprises measuring or monitoring an amount of cryogen stored in the cryogen storage tank, and activating a suitable alarm protocol, by way of the processor, in response to determining that the amount of cryogen in the cryogen storage tank falls below a minimum operating amount of cryogen required for the superconducting device stored therein.

Example 16: The method of Example 14, wherein the method comprises sensing or measuring vibration of, or in, the cryogen storage tank, and activating a suitable alarm protocol, by way of the processor, in response to determining that the vibration sensed is not acceptable.

Example 17: The method of Example 14, wherein the method comprises measuring pressure in the cryogen storage tank and activating a suitable alarm protocol, by way of the processor, in response to determining that the pressure measured is not acceptable.

Example 18: The method of Example 14, wherein the method comprises measuring temperature of the cryogen stored in the cryogen storage tank and activating a suitable alarm protocol, by way of the processor, in response to determining that the temperature of the cryogen in the cryogen storage tank falls outside of a predetermined temperature range.

Example 19: The method of Example 18, wherein the alarm protocol comprises one or more of disconnecting/purging energy to/from the superconducting device, and generating a suitable alarm signal to actuate a suitable alarm device.

Example 20: The method of Example 19, wherein the suitable alarm protocol comprises operating a vacuum pump operatively connected to the cryogen storage tank to reduce vapor pressure in the cryogen storage tank, thereby reducing the temperature of the cryogen in the cryogen storage tank to bring the temperature within the predetermined temperature range.

Example 21: The method of Example 20, wherein the predetermined temperature range is bound by a temperature not greater than a boiling point of the cryogen, and greater than a freezing point of the cryogen.

Example 22: The method of Example 13, wherein the method comprises operating a suitable agitator in the cryogen storage tank so as to at least to maintain a homogenous temperature in the cryogen storage tank.

Example 23: The method of Example 13, wherein the cryogen storage facility comprises:
one or more primary cryogen storage tank/s storing or configured for storing the cryogen; and
at least one secondary cryogen storage tank storing or configured for storing the cryogen, wherein the primary and secondary cryogen storage tanks are in controlled fluid communication with each other, and wherein the secondary cryogen storage tank houses the superconducting device.

Example 24: The method of Example 23, wherein the method comprises transporting cryogen from the primary cryogen storage tank to the secondary cryogen storage tank in response to detecting that a level of cryogen in the secondary cryogen storage tank is below a predetermined threshold and/or transporting cryogen from the secondary cryogen tank to the primary cryogen tank up to a minimum volume of cryogen required in the secondary tank required for the superconducting device.

Example 25: The method of Example 23, wherein the method comprises maintaining the temperature of the cryogen in the primary cryogen storage tank less than or equal to a boiling point of the cryogen.

Example 26: The method of Example 23, wherein the method comprises maintaining the temperature of the cryogen in the secondary cryogen storage tank in a temperature range less than a boiling point of the cryogen and greater than a freezing point of the cryogen.

1. A cryogenic energy storage system comprising:
a cryogen storage facility storing or configured for storing a cryogen;
a cryogen expansion arrangement configured to expand cryogen received from the cryogen storage facility, in use;
a suitable energy generating arrangement configured to be powered by expanding cryogen from the cryogen expansion arrangement to generate electrical energy, in use; and
a superconducting device, located in the cryogen storage facility such that the superconducting device is cooled by the cryogen stored in the cryogen storage facility, in use.

2. The cryogenic energy storage system of claim 1, wherein the superconducting device is selected from a group comprising a superconducting magnet energy storage (SMES) device, superconducting electronics, a superconducting transformer (ST), and a superconducting fault current limiter (SFCL).

3. The cryogenic energy storage system of claim 2, wherein the SMES device is configured to store and output electrical energy, on demand, instead of, or in addition to, the electrical energy generated by the energy generating arrangement.

4. The cryogenic energy storage system of claim 3, wherein the SMES device is configured to provide power to a load operatively connected to the cryogenic energy storage system prior to the energy generating arrangement providing power to said load.

5. The cryogenic energy storage system of claim 3, wherein the SFCL is electrically coupled to an electrical power grid and to a load, wherein the SFCL is configured to limit fault currents from the grid reaching the load.

6. The cryogenic energy storage system of claim 3, wherein the ST is electrically coupled to an electrical power grid and/or to a load.

7. The cryogenic energy storage system of claim 1, wherein the cryogen storage facility comprises a suitable thermally insulated cryogen storage tank storing or configured for storing the cryogen and housing at least the superconducting device therein.

8. The cryogenic energy storage system of claim 7, wherein the system comprises:
a memory device;
a processor coupled to the memory device; and
one or more sensors operatively arranged in the cryogen storage tank operatively connected to the processor to measure one or more parameters and transmit data indicative of the same to the processor, wherein the processor is configured to activate a suitable alarm protocol in response to determining that one or more measured parameters is unacceptable.

9. The cryogenic energy storage system of claim 8, wherein the system comprises a suitable level sensor communicatively coupled to the processor to measure or monitor an amount of cryogen stored in the cryogen storage tank, wherein the processor is configured to activate a suitable alarm protocol in response to determining that the amount of cryogen in the cryogen storage tank, measured by way of the level sensor, falls below a minimum operating amount of cryogen required for the superconducting device.

10. The cryogenic energy storage system of claim 8, wherein the system comprises a suitable vibration sensor communicatively coupled to the processor to sense vibration of, or in, the cryogen storage tank, wherein the processor is configured to activate a suitable alarm protocol in response to determining that the vibration sensed, by way of the vibration sensor, is not acceptable.

11. The cryogenic energy storage system of claim 8, wherein the system comprises a suitable pressure sensor communicatively coupled to the processor to measure the pressure in the cryogen storage tank, wherein the processor is configured to activate a suitable alarm protocol in response to determining that the pressure in the cryogen storage tank, measured by way of the pressure sensor, is not acceptable.

12. The cryogenic energy storage system of claim 8, wherein the system comprises a temperature sensor communicatively coupled to the processor to measure temperature of the cryogen stored in the cryogen storage tank, wherein the processor is configured to activate a suitable alarm protocol in response to determining that the temperature of the cryogen in the cryogen storage tank, measured by way of the temperature sensor, falls outside of a predetermined temperature range or setpoint.

13. The cryogenic energy storage system of claim 8, wherein the alarm protocol includes one or more of disconnecting/purging energy to/from the superconducting device, and generating a suitable alarm signal to actuate a suitable alarm device.

14. The cryogenic energy storage system of claim 12, wherein the system comprises a suitable vacuum pump operatively connected to the cryogen storage tank, wherein the suitable alarm protocol comprises operating the vacuum pump to reduce vapor pressure in the cryogen storage tank, thereby reducing the temperature of the cryogen in the cryogen storage tank to bring the temperature within the predetermined temperature range or setpoint.

15. The cryogenic energy storage system of claim 14, wherein the predetermined temperature range is bound by a temperature not greater than a boiling point of the cryogen, and greater than a freezing point of the cryogen.

16. The cryogenic energy storage system of claim 7, wherein the cryogen storage tank comprises a suitable agitator so as to at least to maintain a homogenous temperature in the cryogen storage tank.

17. The cryogenic energy storage system of claim 7, wherein the cryogen storage facility comprises:
one or more primary cryogen storage tank/s storing or configured for storing the cryogen; and
at least one secondary cryogen storage tank storing or configured for storing the cryogen, wherein the primary and secondary cryogen storage tanks are in controlled fluid communication with each other, and wherein the secondary cryogen storage tank houses the superconducting device.

18. The cryogenic energy storage system of claim 17, wherein the system comprises a suitable pump to transport cryogen between the primary cryogen storage tank and the second cryogen storage tank.

19. The cryogenic energy storage system of claim 18, wherein the pump is operatively located in or adjacent to the primary cryogen storage tank to pump cryogen from the primary cryogen storage tank to the secondary cryogen storage tank so as to maintain a predetermined level of cryogen in the secondary cryogen storage tank.

20. The cryogenic energy storage system of claim 17, wherein the temperature of the cryogen in the primary cryogen storage tank is at a temperature not greater than a boiling point of the cryogen, and wherein the temperature of the cryogen in the secondary cryogen storage tank lies in a temperature range less than the boiling point of the cryogen and greater than a freezing point of the cryogen.

21.-45. (canceled)
